(19) United States
(12) Patent Application Publication
(10) Pub. No.: US 2020/0342379 A1
(43) Pub. Date: Oct. 29, 2020

(54) FORECASTING METHODS

(71) Applicant: Fluidly Limited, London (GB)

(72) Inventors: Thomas William Phillips, London (GB); David John Ball, London (GB)

(21) Appl. No.: 16/855,162

(22) Filed: Apr. 22, 2020

Related U.S. Application Data
(60) Provisional application No. 62/837,976, filed on Apr. 24, 2019.

(51) Int. Cl. G06Q 10/06; G06Q 10/04; G06K 9/62; G06N 20/00

(52) U.S. Cl. CPC G06Q 10/06314; G06N 20/00; G06K 9/6256; G06Q 10/04

(57) ABSTRACT

Pursuant to some embodiments, a sparse time series is converted to a dense time series to allow a forecast to be generated. A day index is identified thereby allowing the forecast to be created with the same daily precision as the input event data.

### CROSS-REFERENCE TO RELATED APPLICATIONS

This application claims the benefit of and priority under 35 USC § 119(e) of U.S. Provisional Patent Application No. 62/837,976, filed on Apr. 24, 2019, the entire disclosure of which is incorporated herein by reference for all purposes.

### BACKGROUND TO THE INVENTION

Cashflow is the lifeblood of any business and the accuracy of forecasting is critical to avoid shortfalls in cash balances, ensuring that payments can be made and ultimately avoid insolvency. The inability to manage cashflow effectively is still a significant cause of small business failure.

Despite being the foundation upon which major financial decisions are made, cashflow forecasting remains a largely manual process based on historic profit and loss data, sales data, averages and ‘best guesses’. With a greater level of transactions, this becomes even more challenging. State of the art software solutions only offer a marginal improvement compared to the use of traditional manual spreadsheet solutions.

An opportunity exists to apply data science and machine-learning to the technical barriers arising from the idiosyncrasies of accounting data to improve computer-based cashflow forecasting, make predictions and reveal insights automatically, at any time, without human input. The objective is to pre-empt issues, identify anomalies and optimise cashflow.

### SUMMARY OF THE INVENTION

According to a first aspect, there is computer implemented method for forecasting calendar-based events occurring during a time period, the events stored in an events database and each event associated with a date, the method comprising creating a first sparse time series representing the events; calculating a predicted periodicity of the events; using the predicted periodicity to create a first dense time series from the first sparse time series; using the first dense time series to create a dense forecast of future events, wherein the dense forecast is represented by a second dense time series; identifying a day index from the first sparse time series; and using the identified day index and dense forecast of future events to create a sparse forecast of future events, wherein the sparse forecast is represented by a second sparse time series.

Conventional time series forecasting methods, such as exponential smoothing and autoregressive integrated moving average, do not work well on sparse time series where zero is meaningful, and they instead make nonsensical forecasts as they are unable to model the calendar-based rule determining the date of the transaction.

Converting the sparse time series to a dense time series allows a forecast to be generated and identifying a day index allows this forecast to be created with the same daily precision as the input event data. In the context of cashflow management, this allows for the generation of accurate cashflow forecasts with daily precision using historical cashflow data, which allows a business to predict its upcoming cashflow transactions and manage its accounts more efficiently.

According to a second aspect, there is a computer implemented method for training a supervised machine learning algorithm to predict a periodicity of calendar-based events, the method comprising determining a plurality of statistics related to a set of training events, each training event associated with a date during a time period; providing the supervised machine learning algorithm with the plurality of statistics; and providing the supervised machine learning algorithm with a periodicity associated with the set of training events.

The number of days between periodic calendar-based events varies due to the different number of days in a calendar month, such as with the Gregorian calendar. Further variation can arise from other phenomena such as business transactions generally occurring on working days, e.g. not weekends and holidays. It is therefore non-trivial to implement a computer-based method for identifying the period of calendar-based events.

Using a plurality of statistics related to a set of training events to train a machine learning algorithm allows such a periodicity to be accurately predicted from historical event data. In the context of cashflow management, it allows the periodicity of cashflow transactions to be identified and used to forecast future transactions.

Although the Gregorian calendar is used as an example, the described methods are applicable to any calendar system in which there may be a variable time between periodic events.

### BRIEF DESCRIPTION OF DRAWINGS

Examples of the present invention will now be described in detail with reference to the accompanying drawings, in which:

FIG. 1 shows an overview of a forecasting system;

FIG. 2 shows an overview of a forecasting method;

FIG. 3 shows a transaction grouping method for use in a forecasting method;

FIG. 4 shows an example of grouping transactions using the method shown in FIG. 3;

FIG. 5 shows a method for predicting the periodicity of events or transactions;

FIG. 6 shows a method for converting a sparse time series to a dense time series;

FIG. 7a shows an example of forecasting using a sparse time series;

FIG. 7b shows an example of forecasting using a dense time series created from a sparse time series;

FIG. 8 shows a method for finding a day index of a sparse time series; and,

FIG. 9 shows a method for converting a dense time series to a sparse time series.

### DETAILED DESCRIPTION

The present invention provides methods for forecasting calendar-based events. Although the methods are described in relation to a cashflow forecasting system, where the forecast is made using historical cashflow data, the methods can be used to make forecasts and predictions in any environment in which events depend on calendar dates, whether that be directly or indirectly.

Calendar-based patterns can occur in practically any field involving human interaction and can be the result of conscious or subconscious human behaviour. For example, the methods described herein can be used to make forecasts in relation to network traffic (there may be certain days of a month that a website sees an increase in users), transportation (people may be more likely to book flights for summer months) or retail sales (people may be more likely to purchase expensive items soon after their salary has been paid). Being able to make accurate and reliable forecasts allows for more efficient allocation of resources.

In the context of cashflow management, computer-implemented methods for identifying the period of calendar-based events allow for accurate large-scale cashflow forecasting from historical transaction data. Due to the variation in the number of days between calendar-based periodic events, period identification is a non-trivial task.

Methods of the present invention enable accurate cashflow forecasts to be created with daily precision. Accurate cashflow forecasting reduces the time that a business must spend managing its accounts and has benefits of allowing the business to make informed decisions about its spending, helping the business to ensure that it can cover payroll expenditure, allowing the business to operate with a lower bank balance, and enabling the business to generally manage its accounts more efficiently. It can also help businesses detect anomalies or late payments at an early stage, thereby allowing the business to take steps to mitigate the effects of any potential cashflow threats.

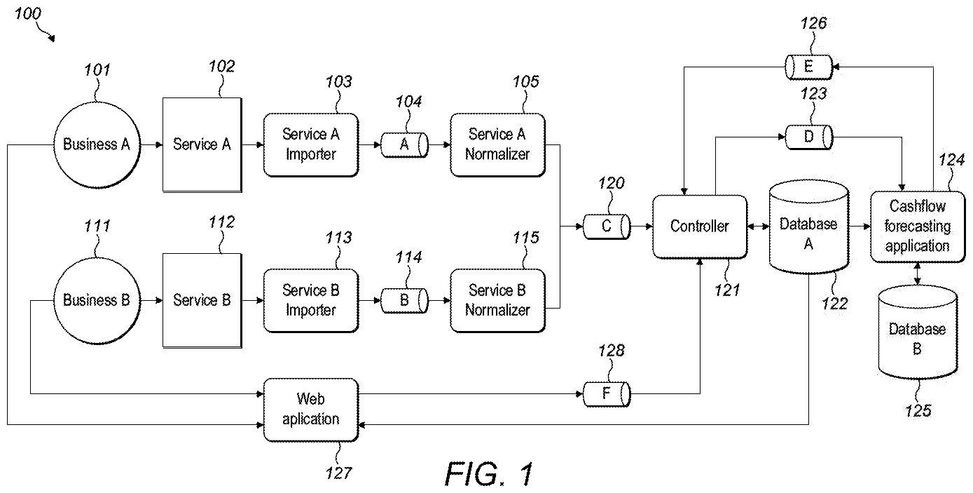

An overview of a cashflow forecasting system 100 used by a cashflow forecasting provider is shown in FIG. 1. Business A 101 and Business B 111 use Service A 102 and Service B 112 respectively for their accounting software, and they use the cashflow forecasting provider to forecast future cashflow transactions using accounting data stored in Service A 102 and Service B 112.

Before the forecasts can be generated, data from Service A 102 and Service B 112 must be imported by the cashflow forecasting provider. Business A 101 authorises the cashflow forecasting provider to access its accounts with Service A 102 via Service A's application programming interface (API), and the cashflow forecasting provider assigns a connection identifier (ID) to uniquely identify Business A 101. The cashflow forecasting provider's Service A

Importer application 103 communicates with the Service A API to obtain Business A's accounting data and publishes the data and its connection ID to message queue A 104.

Similarly, Business B 111 authorises the cashflow forecasting provider to access its accounts via Service B's API, and Business B 111 is assigned a connection ID. The cashflow forecasting providers Service B Importer application 113 communicates with Service B's API to obtain Business B's accounting data and publishes the data and its connection ID to message queue B 114.

Because Service A 102 and Service B 112 may work differently, the data from Service A 102 and Service B 112 contained within queues A 104 and B 114 cannot be compared, so a specific importer and normalizer must be built for each service.

The Service A Normalizer application 105 consumes messages specific to Service A 102 from message queue A 104 and transforms them to conform to the cashflow forecasting provider's data model. Similarly, the Service B Normalizer application 115 consumes messages specific to Service B 112 from message queue B 114 and transforms them to conform to the data model. Both normalizers publish the normalized data to message queue C 120.

The controller 121 consumes the data model messages from queue C 120 and writes them to one or more tables in Database A 122. Records, each identified by connection ID, are inserted into a table if they do not exist already, otherwise the record in the table is updated. Next, the controller 121 updates a read-optimized materialized view of transactions associated with the movement of cash.

After completing the initial import, the cashflow forecasting provider checks for new accounting data at regular intervals or when it receives a push notification from the accounting API indicating the availability of new data. After sufficient data has been obtained from an initial import, when new data has been imported, or at regular intervals (e.g. nightly), the controller 121 publishes a message to message queue D 123 containing the connection ID.

The cashflow forecasting application 124 consumes messages from queue D 123. On consumption of a connection ID, the cashflow forecasting application 124 reads the connection's records from a cash transactions view in Database A 122. The cashflow forecasting application 124 uses the data to compute a cashflow forecast, and data describing the forecast process may be optionally recorded in database B 125 for diagnostic purposes. The cashflow forecasting application publishes messages containing the cashflow forecast to message queue E 126.

The controller 121 consumes the cashflow forecast from message queue E 126 and writes it to database A 122 in a table optimized for fast reads by a web application 127 through which users from Business A 101 and Business B 111 can access the cashflow forecast. Data from users can optionally be published to message queue F 128 by the web application and consumed by the controller 121, which updates the read-optimized views in Database A 122.

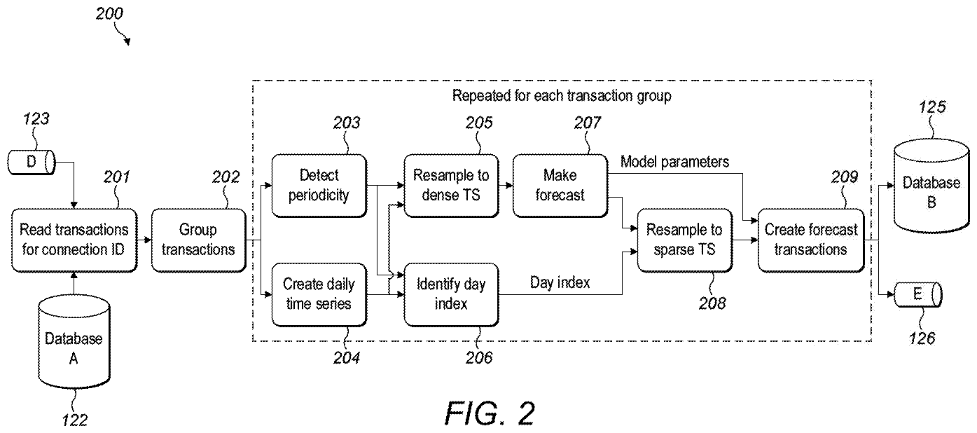

An exemplary forecasting method 200 performed by the cashflow forecasting application 124 is shown in FIG. 2. As previously described, cashflow forecasting starts when the cashflow forecasting application 124 consumes a connection ID from message queue D 123.

At step 201, the cashflow forecasting application 124 reads the connection's records from the cash transactions view in Database A 122. The cashflow forecasting application queries the cash transactions view in Database A 122 for transactions related to that connection ID that are within the relevant time range.

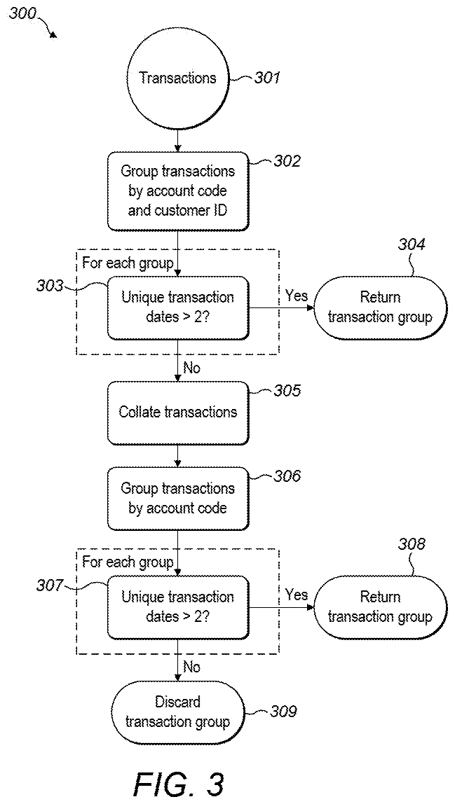

The cashflow forecasting application 124 then groups the transactions at step 202 using the exemplary grouping method 300 shown in FIG. 3. Transactions 301 are firstly grouped by account code and customer ID in step 302, and the number of unique transaction dates is then computed in step 303 for each account-customer transaction group. If the number of unique dates is greater than two, then the transaction group is passed to the next process in step 304.

The remaining transactions, i.e. those for which the number of unique dates is not greater than two, are collated in step 305 and grouped again in step 306, but this time by account code only. The number of unique transaction dates is then computed for each account transaction group in step 307. If an account transaction group has more than two unique transaction dates, it is again passed to the next stage in the process at step 308, otherwise the transaction group is discarded in step 309.

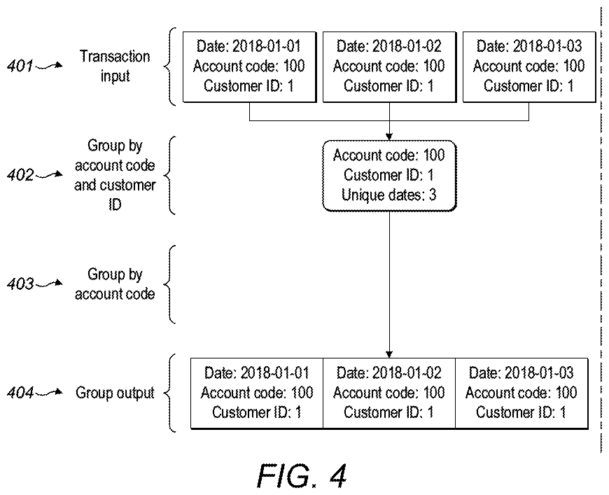

FIG. 4 shows an example of this transaction grouping process. The transaction input 401 is first grouped by account code and customer ID into groups 402, and then into account code groups 403 if the number of unique dates is not greater than two. Transactions that are not discarded following the grouping form the group output 404.

In the example in FIG. 4, there are five groups following the grouping of the transactions in the transaction input by account code and customer ID. The group with account code 100 and customer ID 1 has three unique transaction dates, so it is passed to the next step in the cashflow forecasting application 124. The remaining transactions have two unique dates or fewer and are re-grouped by account code. The group of transactions for account code 100 has three unique transaction dates, so it is also passed to the next step. The remaining group with account code 200 contains a single transaction, so it is discarded.

Returning to FIG. 2, once the transactions are grouped, the predicted periodicity of each group is determined by a prediction engine at stage 203. The prediction engine can use a supervised machine learning classifier approach, such as a random forest classifier, to predict whether a sequence of accounting transactions occur with a weekly, monthly, quarterly, or non-periodic pattern. Detecting the periodicity of calendar-based events is non-trivial due to variation in the length of the periods, and machine learning techniques are well-suited to this task compared to conventional approaches.

In weekly series, the transactions repeat on the same weekday of every week, e.g. Tuesday 1 Jan. 2019, Tuesday 8 Jan. 2019, Tuesday 15 Jan. 2019, and Tuesday 22 Jan. 2019.

In a monthly series, the transactions repeat on the nth day of every month, e.g. 1 Jan. 2019, 1 Feb. 2019, 1 Mar. 2019, and 1 Apr. 2019. Alternatively, transactions can repeat on the nth weekday of every month, e.g. every second Monday of the month, or some other day relative to the month, e.g. the first or last working day of the month.

In a quarterly series, the transactions repeat once per quarter (i.e. every three months). As with a monthly series, this might be the nth day of the quarter (e.g. 1 Jan. 2019, 1 Apr. 2019, and 1 Jul. 2019) or a day relative to the quarter (e.g. 5 Friday of every quarter).

In contrast to a weekly, monthly or quarterly series, a non-periodic series follows no discernible pattern.

In addition to the above series, other periodicities such as fortnightly, six-weekly etc. could also be used by the prediction engine.

Prior to forecasting, the machine learning algorithm must first be trained. The training data used to perform this can be either real-world transaction data or randomly generated transaction data. In either case, the training data must first be manually categorised. This will oftentimes be obvious to a human simply by looking at the data, but manually categorising the training data will generally also involve subjective judgement calls.

While there are seven days between consecutive weekly transactions, the number of days between consecutive monthly and quarterly transactions varies due to the different number of days in a calendar month. There is a mean average of 30.4 days between consecutive monthly transactions, and a mean average of 91.3 days between consecutive quarterly transactions. However, further variation arises from business transactions generally occurring on working days, e.g. not weekends and holidays, and other business events.

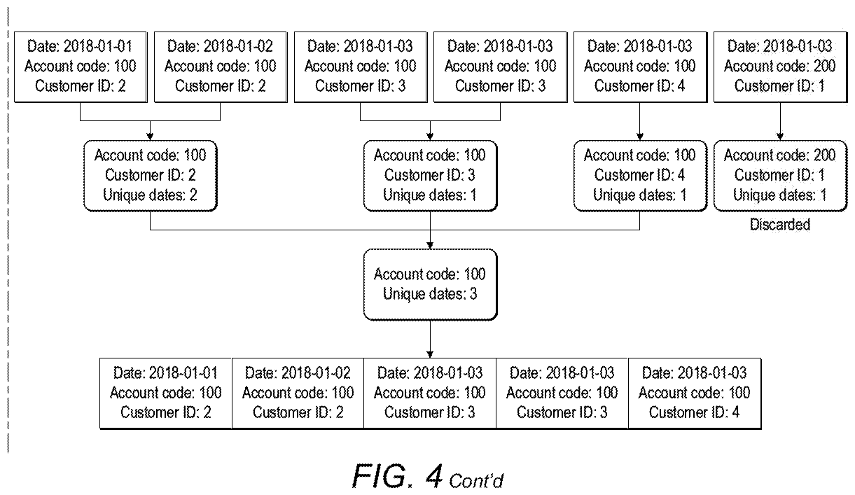

To account for this variation, various statistics relating to the transactions are computed and fed to the prediction engine, as shown in FIG. 5.

The set of unique transaction dates in the input group 501 is obtained at step 502; this set may already have been obtained during the earlier grouping process. The set is then sorted in ascending order at step 503 (the dates could alternatively be sorted in descending order with the same ultimate effect).

At steps 504 and 505, the number of days (referred to as the transaction lifetime) between each pair of successive transaction dates is determined and used to compute various statistics 506a-506f. In particular, the 25th percentile, 50th percentile (median), 75th percentile, maximum and minimum of the transaction lifetimes are calculated.

In addition to the transaction lifetimes and corresponding statistics, a transaction rate 508 (the average number of transactions per day) is computed at step 507 by dividing the total number of transactions by the number of days between the earliest and latest transaction. The number of transactions per month is calculated for each month across the date range at step 509 (including zero for months with no transactions) and used to calculate the standard deviation of the number of events per month 510, and the number of unique dates 511 is also determined.

The statistics 506a-506f, 508, 510 and 511 are all then fed into the prediction engine at step 512, which outputs a prediction of whether the input transactions occur with a weekly, monthly, quarterly, or non-periodic pattern. Training a supervised machine learning algorithm with the statistics 506a-506f, 508, 510 and 511 has been found to result in an accurate machine learning method for predicting the periodicity of calendar-based events.

Algorithm 1 provides a summary of the periodicity prediction method.

Algorithm 1: Periodicity detection using a machine learning classifier.

Input: transaction groups.
For each transaction group:

1. Compute date sequence: unique transaction dates in ascending
order.
2. Compute transaction lifetimes (number of days between successive
transactions).
3. Compute features:

a. descriptive statistics of transaction lifetimes:

i. 25th percentile
ii. 50th percentile (median)
iii. 75th percentile
iv. standard deviation
v. maximum
vi. minimum

b. transaction rate (transactions per day)
c. standard deviation of the number of transaction dates in each
month
d. number of unique dates.

4. Use prediction engine to obtain prediction using computed features.

Output: predicted periodicity for each transaction group.

The machine learning algorithm is trained using the same statistics 506a-506f, 508, 510 and 511 determined from training data comprising a set of training events. However, instead of outputting a forecast, the statistics are provided to the machine learning algorithm with an associated known periodicity, which may be one of weekly, monthly, quarterly or non-periodic.

The next step in the forecasting method of FIG. 2 is the creation of a daily time series in step 204. A time series Y={Yₜ, t∈T} is a set of observations collected sequentially over time T. Here Yₜ denotes the observation of y at time t.

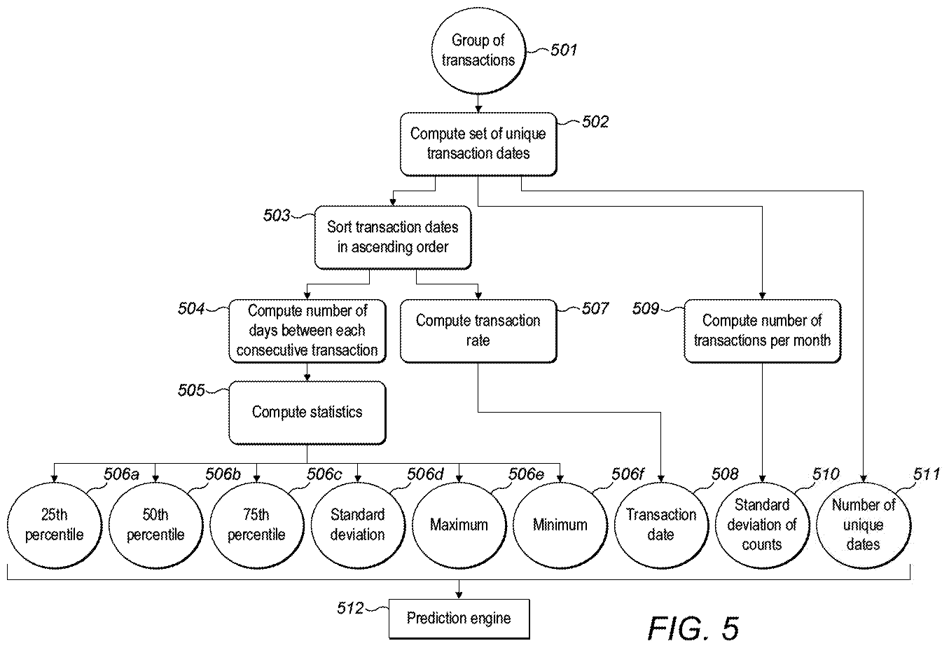

The method 600 for creating a daily time series is shown in FIG. 6. The cash accounting view 601 is queried 602 from a start date dₛ to an end date dₑ (inclusive), and the transactions returned are grouped 603 using the process previously described.

In steps 604-606, each transaction group is transformed into a time series Y by grouping each transaction by date from dₛ to dₑ and calculating the sum of all transactions on each date d. If there are no transactions on a particular date d, then y_{d}=0.

For example, the cash accounting view is queried for transactions with dₛ=1 Jan. 2019 and dₑ=7 Jan. 2019 (a period spanning a week). The transactions are grouped, and each group is converted to a time series with the same index:

T={dₛ, . . . , dₑ}={1 Jan. 2019, 2 Jan. 2019, . . . , 7 Jan. 2019}.

If a group g has transactions on 1 Jan. 2019 for £10, 6 Jan. 2019 for £10 and 6th Jan. 2019 for £5, the group g is transformed to time series G, where a g_{1 Jan. 2019}=£10 and g_{6 Jan. 2019}=£15. All other values are zero because there are no transactions on those dates:

gₜ,=0, t′=T−{1 Jan. 2019, 6 Jan. 2019}.

In cashflow forecasting, the time series obtained with this method are generally sparse, as values for the majority of days are zero. This is because few businesses pay a supplier or receive money from a customer on a daily basis, and most businesses typically pay their creditors at regular intervals following a calendar rule.

Conventional time series forecasting methods, such as exponential smoothing, averaging, naïve models, regressive models and autoregressive integrated moving average, make nonsensical forecasts as they are unable to model the calendar-based rule determining the date of the transaction (e.g. last working day of the month or quarter). They do not work well on sparse time series where zero is meaningful and are instead best suited for forecasting continuous values like asset prices or populations.

Croston's method is a widely used method for forecasting time series with meaningful zeros. Croston's method uses exponential smoothing to forecast the non-zero values of a time series, and it separately uses exponential smoothing to forecast the time between non-zero values. However, this approach fails to model calendar-based recurrence correctly because the time between consecutive monthly or quarterly transactions varies.

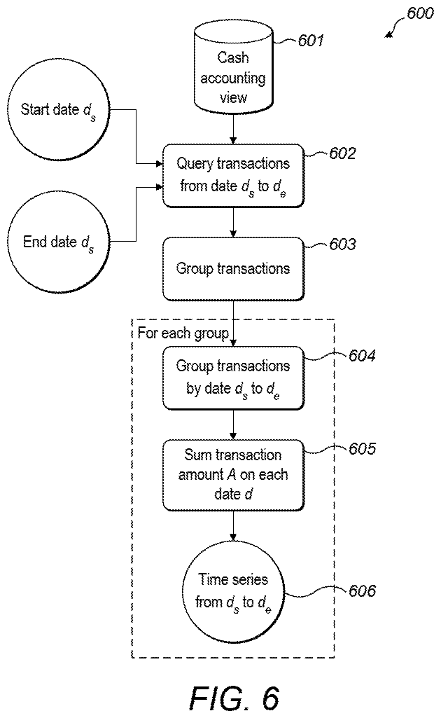

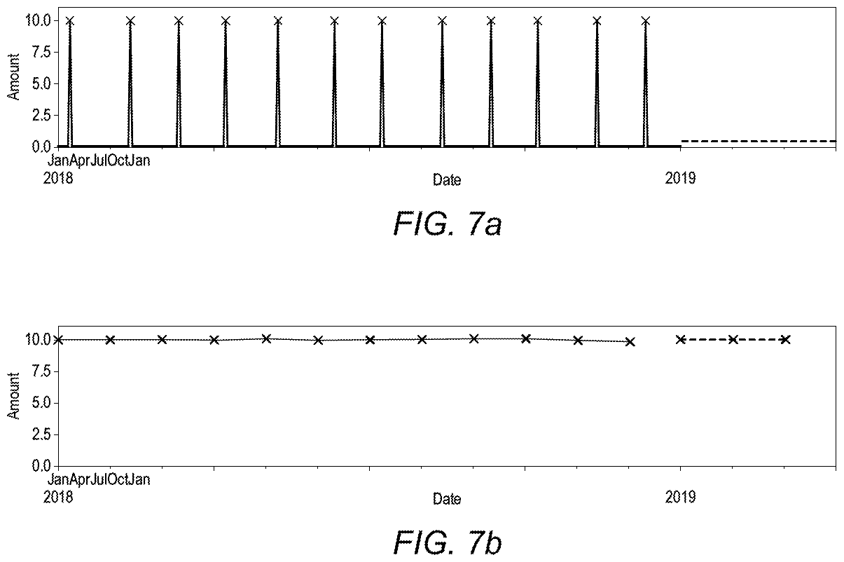

FIG. 7a shows a plot of a time series for an account credited with around £10 on the second Monday of every month in 2018 and the mean forecast for the next three months using conventional methods. The transaction falls on different days each month because the number of days in a month varies, and the time series is sparse (most days have a value of £0). In this case, conventional methods would forecast a value of £0.33 for every day, as shown by the dashed line.

To overcome this problem, at step 205 of FIG. 2 the predicted periodicity calculated in step 203 is used to resample the sparse daily time series from step 204 into the predicted period (i.e. the sparse time series is divided into periods equal to the predicted period, and the entries in each period are combined into a single entry representing the period in a new time series). This has the benefit of converting the sparse time series into a dense time series suitable for forecasting at step 207 using the established methods mentioned above.

FIG. 7b shows a plot of the same time series as FIG. 7a, for an account credited with around £10 on the second Monday of every month in 2018, but resampled using a monthly periodicity. Every value in the time series is now non-zero, so a forecast of for future months can be computed using established methods. In this case the mean forecast is £9.98 per month, as represented by the dashed line.

However, resampling to a dense time series means that the forecast, which is also a dense time series, only has monthly precision, whereas the input data had daily precision. Daily precision is desirable to a business, for example the business may need to know whether it is likely to cover expenditures such as staff payroll on a particular day.

To overcome this problem, a day index is identified from the sparse daily time series at step 206, and this is used at step 208 to resample the dense forecast time series to a sparse forecast time series. This has the benefit of increasing the precision of the forecast.

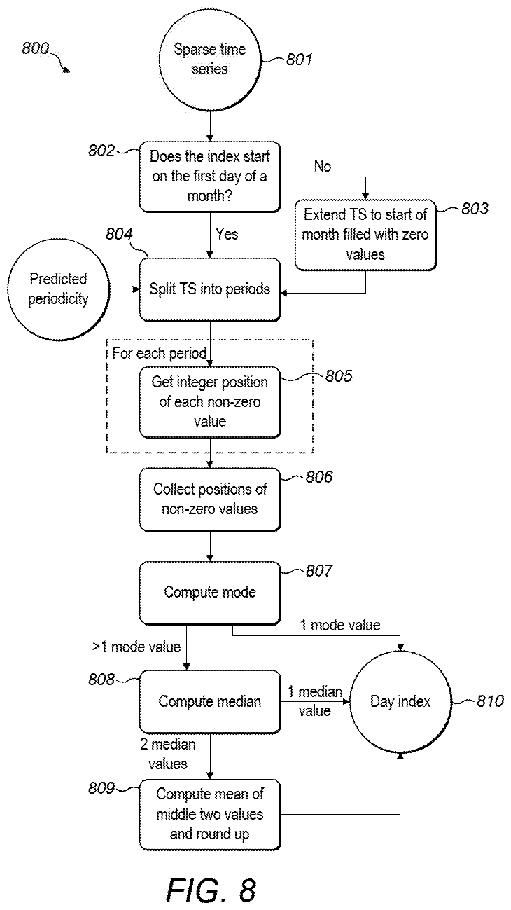

The day index is identified using the method 800 shown in FIG. 8. The sparse times series 801 is the first input into the algorithm, and it is determined at step 802 whether the first day of the time series is the first day of a calendar month. If it is not, the time series is extended back to the start of the month using zeros to fill the missing values in step 803.

The method then proceeds to step 804, at which point the sparse time series is split into calendar weeks, months or quarters using the periodicity predicted with the methods above. The positions of non-zero values are then found in step 805 for each period, and these positions are collected together in step 806.

The mode index is then determined in step 807. If there is a single mode, this is used as the day index 810. However, if there is more than one modal value, the method proceeds to calculate the median in step 808. If there is a single median value, this is used as the day index 810. If there are two median values, the ceiling of the mean of the two median values is calculated at step 809 and used as the day index 810.

For example, for a series with a weekly periodicity with five weeks with transactions on Wednesdays, the index of non-zero values is 3, 3, 3, 3, 3, and the day index is 3, which is the mode.

For a time series with a monthly periodicity with six months with transactions on the last working of the month, the index of non-zero values might be 31, 28, 29, 30, 31, 28. In this case, the day index is 30, which is the median rounded up.

For a time series with a quarterly periodicity with three quarters with transactions on 15 February, 17 May, and 16 August the index of non-zero values is 46, 47, 47, and the day index is 47, which is the mode.

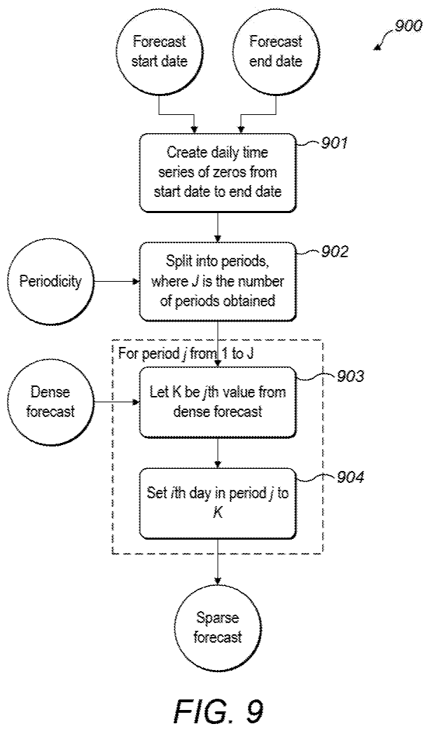

Once the daily index has been identified, the method of FIG. 2 proceeds to step 208, at which point the dense forecast time series is resampled to a sparse forecast time series using the method 900 in FIG. 9. In general, a forecast will start from the day immediately after the last day in the historical time series, and the end date will be chosen arbitrarily, for example a year later.

The method starts in step 901 with the creation of a daily forecast time series of zeros from the start date to the end date. The daily forecast time series is then split into periods in step 902 using the previously calculated predicted periodicity. For example, weekly periods might start on Mondays, monthly periods might start on the first day of every month, and quarterly periods might start on 1 January, 1 April, 1 July, and 1 October.

The method then proceeds by iterating through the dense forecast values in lock-step with the periods from the sparse forecast time series. The value corresponding to the period is obtained from the dense forecast in step 903, and the day index is used to select a transaction day within the period in the sparse forecast and set it to this value in step 904.

For example, the day index is used to select a transaction day in the first period in the sparse forecast time series, and the value on this day is set to the first value in the dense forecast. The method then moves to the second period in the sparse forecast time series, again selecting the transaction day within the period using the day index and setting this value to the second value in the dense forecast time series. This process is repeated until periods in the sparse forecast time series are exhausted.

In general, given day index i, the ith day in the period is selected as the transaction day. However, there are two exceptions.

The first exception occurs when the first day in the sparse forecast period is not a Monday, the first day of a month, or the first day of a quarter for weekly, monthly and quarterly periodicities respectively. In this case, we calculate how many days there are between the start of the week, month or quarter and the first day in the period and call this the offset. The transaction day is offset by the number of days between the start of the week, month or quarter and the first day in the period. For example, if a weekly period starts on a Wednesday, then the offset is two. If the day index is 5 (i.e. Fridays), then the transaction day is (5−2)=3rd day of the current period (i.e. Friday).

The second exception occurs if the day index is greater than the number of days within the period. If the last day of the selected period is the last day of a week, month or quarter, the last day of the period is chosen instead. This accounts for scenarios like a day index of 30 being applied to February with 28 days, thereby preventing a February transaction being forecast for March.

As a penultimate step in the forecasting, any transactions on non-working days are moved to the nearest working day.

Finally, returning again to FIG. 2, the non-zero values in the sparse forecast time series are turned into transaction objects in step 209 and persisted in the database 125. Attributes of the transactions are populated from the attributes of the original group (account code and customer ID), including the predicted periodicity. The cashflow forecast is published to message queue E 126, and data describing the forecast process may be optionally recorded in Database B 125.

Forecasts can then be viewed by users Business A 101 and Business B 111, for example using the web application 127. Forecasts for each group may be viewed alone or they may alternatively be combined as necessary, for example to give a forecast for a particular account or for all accounts.

One skilled in the art will readily understand that the order of the method steps described above could be changed without affecting the method. In addition, some of the steps could be combined or omitted.

The above method describes periodicity prediction and forecasting methods in relation to cashflow forecasting, and all events have been referred to as transactions. Some of the steps described above, such as importing, normalising and grouping account data, may not be necessary for forecasting calendar-based events in other situations, such as when forecasting network traffic.

Any of the above methods or method steps could be stored on computer readable media as instructions to be executed by one or more processors. Likewise, any of the above methods or method steps could be performed by a processor.

Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

1. A computer implemented method for forecasting calendar-based events occurring during a time period, the events stored in an events database and each event associated with a date, the method comprising:
creating a first sparse time series representing the events;
calculating a predicted periodicity of the events;
using the predicted periodicity to create a first dense time series from the first sparse time series;
using the first dense time series to create a dense forecast of future events, wherein the dense forecast is represented by a second dense time series;
identifying a day index from the first sparse time series; and,
using the identified day index and dense forecast of future events to create a sparse forecast of future events, wherein the sparse forecast is represented by a second sparse time series.

2. The method of claim 1, wherein creating the first sparse time series comprises:
querying the events database between a start date and an end date; and,
calculating a total of events associated with each queried date.

3. The method of claim 1, wherein calculating the predicted periodicity comprises:
determining a plurality of statistics related to the events;
providing the plurality of statistics to a prediction engine; and,
calculating a predicted periodicity of events.

4. The method of claim 3, wherein the prediction engine comprises a supervised machine learning algorithm.

5. The method of claim 3, wherein the plurality of statistics comprises two or more of the following:
a total number of unique dates associated with the events;
a standard deviation of a number of events associated with each of one or more months in the time period;
an event rate; and,
one or more statistics relating to a number of days between successive dates associated with events.

6. The method of claim 5 wherein the one or more statistics relating to a number of days between successive dates associated with events comprise one or more of the following:
a 25th percentile of the number of days between successive dates associated with events;
a 50th percentile of the number of days between successive dates associated with events;
a 75th percentile of the number of days between successive dates associated with events;
a standard deviation of the number of days between successive dates associated with events;
a maximum of the number of days between successive dates associated with events; and,
a minimum of the number of days between successive dates associated with events.

7. The method of claim 5, wherein determining one or more statistics relating to the number of days between successive dates associated with events comprises:
computing a set of unique dates associated with events;
sorting the set of unique dates; and,
computing the number of days between each pair of successive dates associated with events.

8. The method of claim 5, wherein determining an event rate comprises calculating an average number of events per day during the time period.

9. The method of claim 3, wherein calculating a predicted periodicity of events comprises classifying the events using a pre-determined set of calendar-based classification periods.

10. The method of claim 9, wherein the pre-determined set of calendar-based classification periods comprises one or more of weekly, fortnightly, monthly, quarterly, and non-periodic.

11. The method of claim 1, wherein using the predicted periodicity to create a first dense time series from the first sparse time series comprises resampling the first sparse time series into periods equal to the predicted periodicity.

12. The method of claim 1, wherein creating the dense forecast of future events comprises using a time series forecasting method.

13. The method of claim 12, wherein the time series forecasting method is an exponential smoothing model, an average model, a naïve model, a regressive model or an autoregressive integrated moving average model.

14. The method of claim 1, wherein identifying the day index comprises:
dividing the sparse time series into periods using the predicted periodicity;
for each period, determining an integer position of each non-zero value in the period; and,
determining a statistic of determined integer positions.

15. The method of claim 14, wherein the statistic of determined integer positions is a mode.

16. The method of claim 15, further comprising:
if there is more than one mode, determining a median of integer positions; and,
if there are two median values, computing the ceiling of the mean of the two median values.

17. The method of claim 1, wherein using the identified day index and dense forecast of future events to create a sparse forecast of future events comprises:
creating an empty daily time series between a forecast start date and a forecast end date;
dividing the daily time series into periods using the predicted periodicity;
simultaneously iterating through the periods of the daily time series and through the dense forecast between the forecast start date and the forecast end date; and,
for each iteration, setting a forecast value of a forecast day in the daily time series a corresponding value from the dense forecast, wherein the forecast day corresponds to the day index.

18. A computer implemented method for training a supervised machine learning algorithm to predict a periodicity of calendar-based events, the method comprising:
determining a plurality of statistics related to a set of training events, each training event associated with a date during a time period;
providing the supervised machine learning algorithm with the plurality of statistics; and,
providing the supervised machine learning algorithm with a periodicity associated with the set of training events.

19. The method of claim 18, wherein the plurality of statistics comprises two or more of the following:
a total number of unique dates associated with the training events;
a standard deviation of a number of training events associated with each of one or more months in the time period;
a training event rate; and,
one or more statistics relating to a number of days between successive dates associated with training events.

20. The method of claim 19, wherein the one or more statistics relating to a number of days between successive dates associated with training events comprise one or more of the following:
a 25th percentile of the number of days between successive dates associated with training events;
a 50th percentile of the number of days between successive dates associated with training events;
a 75th percentile of the number of days between successive dates associated with training events;
a standard deviation of the number of days between successive dates associated with training events;
a maximum of the number of days between successive dates associated with training events; and,
a minimum of the number of days between successive dates associated with training events.

21. The method of claim 19, wherein determining one or more statistics relating to the number of days between successive dates associated with training events comprises:
computing a set of unique dates associated with training events;
sorting the set of unique dates; and,
computing the number of days between each pair of successive dates associated with training events.

22. The method of claim 19, wherein determining a training event rate comprises calculating an average number of training events per day during the time period.

23. The method of claim 18, wherein the periodicity associated with the set of training events is one of a pre-determined set of calendar-based classification periods.

24. The method of claim 23, wherein the pre-determined set of calendar-based classification periods comprises one or more of weekly, fortnightly, monthly, quarterly, and non-periodic.
